(19) United States
(12) Patent Application Publication
(10) Pub. No.: US 2026/0269378 A1
(43) Pub. Date: Sep. 10, 2026

(54) POUCH-TYPE SECONDARY BATTERY AND METHOD OF MANUFACTURING THE SAME

(71) Applicant: SK On Co., Ltd., Seoul (KR)

(72) Inventor: Myeong Seon KWON, Daejeon (KR)

(21) Appl. No.: 19/558,345

(22) Filed: Mar. 5, 2026

(30) Foreign Application Priority Data
Mar. 7, 2025 (KR) 10-2025-0029657

(51) Int. Cl. H01M 50/105; H01M 10/058; H01M 50/178; H01M 50/186; H01M 50/191; H01M 50/193; H01M 50/197; H01M 50/198

(52) U.S. Cl. CPC H01M 50/105; H01M 10/058; H01M 50/178; H01M 50/186; H01M 50/191; H01M 50/193; H01M 50/197; H01M 50/198

(57) ABSTRACT

According to one embodiment of this disclosure, a pouch-type secondary battery includes an electrode assembly and a pouch accommodating the electrode assembly, the pouch including a sealing portion sealing an external surface of the pouch and an inorganic coating layer formed on an external surface of the sealing portion, wherein the sealing portion may include a coating portion in which the inorganic coating layer is formed on the external surface of the sealing portion and a non-coating portion in which the inorganic coating layer is not formed on the external surface of the sealing portion.

### CROSS-REFERENCE TO RELATED APPLICATIONS

This patent document claims the priority and benefits of Korean Patent Application No. 10-2025-0029657, filed on Mar. 7, 2025, the disclosure of which is incorporated herein by reference in its entirety.

### TECHNICAL FIELD

The present disclosure relates to a pouch-type secondary battery and a method of manufacturing the same.

### BACKGROUND

Recently, research into environmentally friendly vehicles, such as electric vehicles (EVs), which can replace fossil fuel-powered vehicles that are one of the main causes of air pollution, has been actively conducted, and lithium secondary batteries with high discharge voltage and stable output have mainly been used as power sources for such vehicles.

The lithium secondary battery may be manufactured in various forms. Thereamong, a pouch-type secondary battery is a form that uses a pouch as a battery case, and includes an electrode assembly embedded in the pouch for charging and discharging electrical energy. To improve the thermal stability and electrochemical stability of the secondary battery, a pouch having excellent thermal characteristics and insulation resistance characteristics is required.

### SUMMARY

The present disclosure can be implemented in some embodiments to provide a pouch-type secondary battery having improved thermal stability.

The present disclosure can be implemented in some embodiments to provide a pouch-type secondary battery having improved mechanical stability.

The present disclosure can be implemented in some embodiments to provide a pouch-type secondary battery having a reduced rate of insulation resistance defects.

The present disclosure can be implemented in some embodiments to provide a pouch-type secondary battery facilitating a prompt and effective response in the event of thermal propagation.

In some embodiments of the present disclosure, a pouch-type secondary battery includes an electrode assembly and a pouch accommodating the electrode assembly, the pouch including a sealing portion sealing an external surface of the pouch and an inorganic coating layer formed on an external surface of the sealing portion, wherein the sealing portion may include a coating portion on which the inorganic coating layer is formed and a non-coating portion on which the inorganic coating layer is not formed.

The pouch-type secondary battery may further include an electrode lead connected to the electrode assembly and partially exposed to the outside of the pouch.

The electrode lead may include a first electrode lead and a second electrode lead, different from the first electrode lead.

The sealing portion may include a first sealing portion on a side on which a first electrode lead is located, and a second sealing portion on a side on which a second electrode lead is located.

The coating portion may be formed in a region that includes a portion of at least one of the first and second sealing portions.

The coating portion may be formed on at least part of the first sealing portion or the second sealing portion.

The coating portion may be formed on a sealing end portion and on an electrode lead end portion at the side of the first sealing portion where the first electrode lead is located, or on a sealing end portion and on an electrode lead end portion at the side of the second sealing portion where the second electrode lead is located.

The inorganic coating layer may include at least one selected from the group consisting of metal oxides and carbides.

The metal oxide may include at least one selected from the group consisting of aluminum oxide, chromium oxide, titanium oxide, zirconium oxide, and yttrium oxide.

The carbide material may include at least one carbide selected from the group consisting of tungsten carbide and chromium carbide.

The inorganic coating layer may have a thickness of 1 to 200 μm.

In some embodiments of the present disclosure, a method of manufacturing a pouch-type secondary battery includes providing a pouch-type secondary battery in which an electrode assembly is accommodated in a pouch; and forming an inorganic coating layer on an external surface of a sealing portion sealing the pouch, wherein the sealing portion may include a coating portion having the inorganic coating layer formed on its external surface and a non-coating portion on which the inorganic coating layer is not formed.

The forming the inorganic coating layer may be performed by at least one method selected from the group consisting of plasma spray coating, brush coating, decal coating, slot die coating, inkjet printing, spin coating, and dip coating.

### Advantageous Effects

According to an embodiment of the present disclosure, the thermal stability of a pouch-type secondary battery can be improved.

According to an embodiment of the present disclosure, the mechanical stability of the pouch-type secondary battery may be improved.

According to an embodiment of the present disclosure, the insulation resistance defect rate of a pouch-type secondary battery may be improved.

According to an embodiment of the present disclosure, the pouch-type secondary battery may facilitate an easy response to thermal propagation.

### BRIEF DESCRIPTION OF DRAWINGS

FIG. 1 is a plan view schematically illustrating a pouch-type secondary battery according to an embodiment of this disclosure as viewed from above.

FIG. 2 is a perspective view schematically illustrating a pouch-type secondary battery according to an embodiment of this disclosure.

FIG. 3 is a diagram schematically illustrating example positions of first and second electrode leads and first and second sealing portions of a pouch-type secondary battery according to an embodiment of this disclosure.

FIGS. 4 to 6 are schematic plan views illustrating a pouch-type secondary battery having a coating portion formed according to various embodiments of this disclosure, as viewed from above.

### DETAILED DESCRIPTION

Features of the present disclosure disclosed in this patent document are described by example embodiments with reference to the accompanying drawings.

Hereinafter, the techniques disclosed herein and embodiments thereof will be described in detail with reference to the accompanying drawings. However, the embodiments of this disclosure may be modified in various ways, and their scope is not limited to the examples described below. Further, the techniques disclosed herein may not only be limited to the configurations of the embodiments described below, but also may be implemented by selectively combining all or part of the respective embodiments so that various modifications can be made.

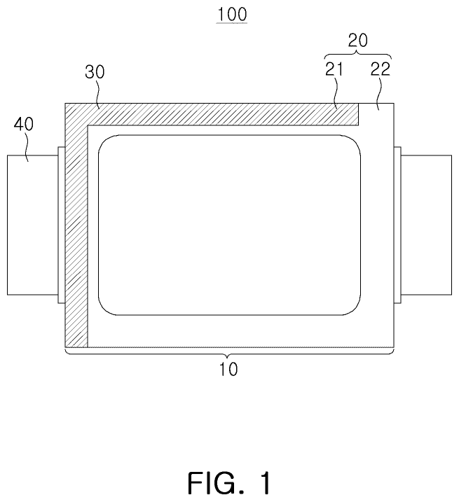

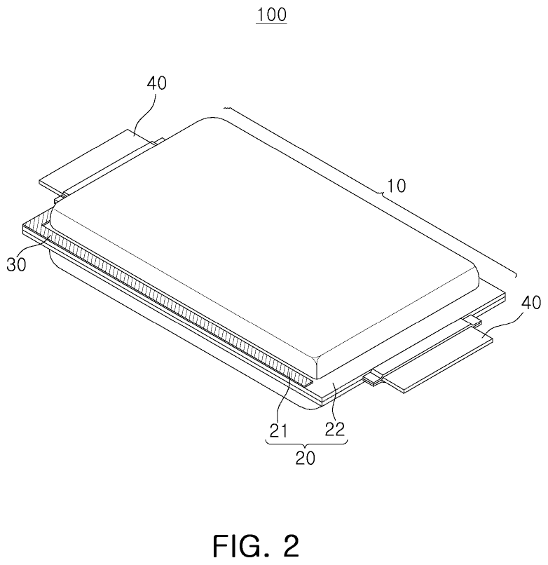

FIG. 1 is a plan view schematically illustrating a pouch-type secondary battery according to an embodiment of this disclosure as viewed from above. FIG. 2 is a perspective view schematically illustrating the shape of the pouch-type secondary battery according to an embodiment of this disclosure.

### Pouch-Type Secondary Battery

A pouch-type secondary battery according to one embodiment of this disclosure is a pouch-type secondary battery comprising: an electrode assembly; and a pouch accommodating the electrode assembly, the pouch comprising a sealing portion configured to seal an external surface of the pouch and an inorganic coating layer formed on an external surface of the sealing portion, wherein the sealing portion may include a coating portion on which the inorganic coating layer is formed on the sealing portion's external surface, and a non-coating portion on which the inorganic coating layer is not formed on the sealing portion's external surface.

The pouch-type secondary battery can improve poor insulation resistance and enhance safety in the event of thermal propagation by forming an inorganic coating layer on a portion of the external surface of the sealing portion. The inorganic coating layer is formed on the external surface of the sealing portion and can enhance thermal stability, electrochemical stability, and mechanical stability.

Referring to FIGS. 1 and 2, a pouch-type secondary battery according to an embodiment of this disclosure will be described in detail.

The pouch may include a sealing portion sealing an external surface of the pouch in which the electrode assembly is accommodated, and an inorganic coating layer formed on the external surface of the sealing portion. The sealing portion may be a region where electrochemical stability and durability are weak, and thus where insulation resistance defects primarily occur. Accordingly, when the inorganic coating layer is formed on at least a portion of the external surface of the sealing portion, it can increase the non-conductivity of the region where insulation resistance defects primarily occur, thereby reducing the incidence of insulation resistance defects in the pouch. In addition, the sealing portion is a portion susceptible to mechanical defects due to low durability, and when the inorganic coating layer is formed on at least a portion of the sealing portion, the thermal and mechanical stability of the pouch may be improved. The form and structure of the sealing portion are not particularly limited so long as the sealing portion is provided on the external surface of the pouch and is capable of sealing the electrode assembly.

The sealing portion may include a coating portion on its external surface, on which an inorganic coating layer is formed, and a non-coating portion on its external surface, on which no inorganic coating layer is formed. By including the coating portion, the sealing portion may reduce the pouch's insulation resistance failure rate as described above and may improve thermal and mechanical stability. Further, by including the non-coating portion, the sealing portion may be configured such that the vent location of gas generated inside the pouch during thermal propagation is determined to be the non-coating portion, thereby preventing uncontrolled venting and facilitating the prediction of the gas discharge path to enable an easier response.

The structure of the electrode assembly is not particularly limited. For example, the electrode assembly may have a structure including one or more unit cells, and each unit cell may include a positive electrode and a negative electrode.

The positive electrode and the negative electrode each include a current collector and a composite layer formed on at least one surface of the current collector. The types and thicknesses of the positive electrode current collectors and the negative electrode current collectors are not particularly limited. For example, an aluminum foil (Al foil) may be applied as the positive electrode current collector, and a copper foil (Cu foil) may be applied as the negative electrode current collector. In addition, the thicknesses of the positive electrode current collector and the negative electrode current collector may each be, for example, 10 to 50 μm.

The cathode mixture layer and the anode mixture layer are active layers comprising an active material that substantially participates in the electrochemical reaction of a secondary battery, wherein the cathode mixture layer includes a cathode active material, and the anode mixture layer may include an anode active material.

The positive electrode active material is not particularly limited and may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered or crystalline structure represented by the following Chemical Formula 1.

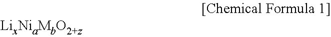

In Chemical Formula 1, x may be 0.9 to 1.2, a may be 0.6 to 0.99, b may be 0.01 to 0.4, and z may be −0.5 to 0.1. As described above, M may include Co, Mn, and/or Al.

The chemical structure represented by Chemical Formula 1 indicates the bonding relationships present in the layered or crystalline structure of a positive electrode active material and does not exclude the presence of additional elements. For example, M may include Co and/or Mn, and Co and/or Mn may be provided together with Ni as the main active elements of the positive electrode active material. Chemical Formula 1 is provided to express the bonding relationships among the main active elements and should be understood to encompass the introduction and substitution of additional elements.

In one embodiment, auxiliary elements may be further included in addition to the main active element to enhance the chemical stability of the positive electrode active material or of the layered or crystalline structure. The auxiliary elements may be co-incorporated into the layered or crystalline structure to form bonds, and in this case, should be understood to be included within the chemical structural scope represented by Chemical Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, and Zr. The auxiliary element may, for example, act as an auxiliary active element, such as Al, that contributes with Co or Mn to the capacity and output activity of the positive electrode active material.

For example, the cathode active material or the lithium-nickel metal oxide may include a layered or crystalline structure represented by Chemical Formula 1-1.

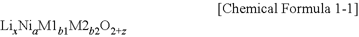

In Chemical Formula 1, M1 may include Co, Mn, and/or Al. M2 may include the aforementioned auxiliary element. In Chemical Formula 1-1, 0.9≤×≤1.2, 0.6≤a≤0.99, 0.01≤b1+b2≤0.4, and −0.5≤z≤0.1.

The cathode active material may further include a coating element or a dopant. For example, elements substantially the same as or similar to the aforementioned auxiliary elements may be used as a coating element or a dopant. For example, one of the aforementioned elements may be used alone, or two or more of the aforementioned elements may be used in combination as the coating element or a dopant.

The coating element or the doping element may be present on the surface of the lithium-nickel metal oxide particles, or may penetrate through the surface of the lithium-nickel metal composite oxide particles to be incorporated into the bonding structure represented by Chemical Formula 1 or Chemical Formula 1-1.

The cathode active material may include a nickel-cobalt-manganese (NCM)-based lithium oxide. In this case, an NCM-based lithium oxide having an increased nickel content may be used.

Ni may be provided as a transition metal associated with the power output and capacity of a lithium secondary battery. Therefore, as described above, by employing a high-Ni composition in the positive electrode active material, a high-capacity positive electrode and a high-capacity lithium secondary battery can be provided.

However, as the Ni content increases, the long-term storage stability and cycle life of the positive electrode or the secondary battery may be relatively reduced, and side reactions with the electrolyte may increase. However, according to exemplary embodiments, including Co maintains electrical conductivity, while Mn improves cycle life and capacity retention characteristics.

The amount of Ni in the lithium nickel cobalt manganese oxide (NCM) (e.g., the mole fraction of nickel among the total moles of nickel, cobalt, and manganese) may be 0.6 or greater, 0.7 or greater, or 0.8 or greater. In some embodiments, the amount of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO4).

In some embodiments, the cathode active material may include, for example, a Mn-rich active material having a chemical structure or a crystal structure represented by Chemical Formula 2; a Li-rich layered oxide (LLO) or an over-lithiated oxide (OLO) active material; and a cobalt-free active material.

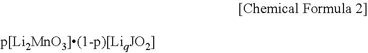

In Chemical Formula 2, 0<p<1, 0.9≤q≤1.2, and J is selected from the group consisting of Mn, Ni, Co, Fe, Cr, V, Cu, Zn, Ti, Al, Mg, and B.

The anode active material is not particularly limited and may include a material capable of adsorbing and desorbing lithium ions. For example, the anode active material may be a carbon-based material such as crystalline carbon, amorphous carbon, a carbon composite, or carbon fiber; lithium metal; a lithium alloy; a silicon (Si)-containing material; or a tin (Sn)-containing material.

Examples of amorphous carbon include hard carbon, soft carbon, coke, mesocarbon microbeads (MCMB), mesophase pitch-based carbon fibers (MPCF), and the like.

Examples of crystalline carbon include graphitic carbon, such as natural graphite, artificial graphite, graphitized coke, graphitized MCMB, and graphitized MPCF.

The lithium metal may be pure lithium metal or lithium metal having a protective layer formed to suppress dendrite growth. In one embodiment, a lithium metal-containing layer deposited or coated on an anode current collector may be used as an anode active material layer. In one embodiment, a lithium thin-film layer may be used as an anode active material layer.

The lithium alloy may include one or more of the following elements: aluminum, zinc, bismuth, cadmium, antimony, silicon, lead, tin, gallium, and indium.

The silicon-containing material may provide increased capacity characteristics. The silicon-containing material may include Si, SiOx(0<x<2), carbon-coated SiOx(0<x<2), metal-doped SiOx(0<x<2), a silicon-carbon composite, and the like. The metal may include lithium and/or magnesium, and the metal-doped SiOx(0<x<2) may include metal silicates.

The anode mixture layer and the cathode mixture layer may each further include a conductive material. The conductive material is not particularly limited, and may, for example, be at least one selected from graphite such as natural graphite or artificial graphite; carbon-based materials such as carbon black, acetylene black, Ketjen black, channel black, furnace black, lamp black, thermal black, carbon fibers, and carbon nanotubes (CNTs); metal powders or metal fibers such as copper, nickel, aluminum, and silver; conductive whiskers such as zinc oxide and potassium titanate; conductive metal oxides such as titanium oxide; and conductive polymers such as polyphenylene derivatives. When the anode mixture layer further includes a conductive material, the amount thereof may, for example, be 0.1 to 5 wt % based on the total weight of the anode mixture layer. When the cathode mixture layer further includes a conductive material, the amount thereof may, for example, be 0.1 to 5 wt % based on the total weight of the cathode mixture layer.

The positive electrode mixture layer and the negative electrode mixture layer may each further include a binder. The binder is not particularly limited. The binder included in the positive electrode mixture layer may be, for example, at least one selected from polyvinylidene fluoride (PVDF), polyvinyl alcohol (PVA), polyvinylpyrrolidone (PVP), carboxymethylcellulose (CMC), ethylcellulose, an acrylic resin, styrene-butadiene rubber (SBR), and polytetrafluoroethylene (PTFE). In addition, the binder included in the negative electrode mixture layer may be, for example, at least one selected from the group consisting of rubber-based binders such as styrene-butadiene rubber (SBR), fluorine-based rubber, ethylene-propylene rubber, butyl acrylate rubber, butadiene rubber, isoprene rubber, acrylonitrile rubber, acrylic rubber, and silane-based rubber; and cellulose-based binders such as carboxymethylcellulose (CMC), hydroxypropylmethylcellulose, and methylcellulose, or alkali metal salts (Na, K, or Li) thereof. When the positive electrode mixture layer further includes a binder, the content thereof may be, for example, 0.1 to 5 wt % based on the total weight of the positive electrode mixture layer. In addition, when the negative electrode mixture layer further includes a binder, the content thereof may be, for example, 0.1 to 5 wt % based on the total weight of the negative electrode mixture layer.

The unit cell according to the above-described embodiments may not include a separator between the positive electrode and the negative electrode, or may further include a separator. When the unit cell further includes a separator, the separator may be a polyolefin-based polymer separator such as polyethylene or polypropylene; glass fiber; polyester; polytetrafluoroethylene; or a combination thereof, and may be in the form of a nonwoven fabric or a woven fabric. In addition, the separator may be coated with a composition including a ceramic component or the like to secure heat resistance or mechanical strength, and may be optionally configured as a single-layer or multilayer structure. A separator having the above-described compounds, structures, or the like may be applied, but is not limited thereto.

The unit cell included in the pouch-type secondary battery according to the above-described embodiments may further include a solid electrolyte. That is, the unit cell included in the pouch-type secondary battery may include a solid electrolyte without a separator between the positive electrode and the negative electrode. The solid electrolyte is not particularly limited and may, for example, be an oxide-based solid electrolyte, a sulfide-based solid electrolyte, or a polymer-based solid electrolyte.

Hereinafter, a method of manufacturing a unit cell according to the embodiments described above will be described in detail.

The method of manufacturing the unit cell according to the above-described embodiments is not particularly limited; for example, in the case of the positive electrode, a positive electrode slurry including the first and second positive electrode active materials may be applied onto a positive electrode current collector by bar coating, casting, spraying, or the like, and the positive electrode slurry may be dried at 100 to 140° C. to form a positive electrode composite layer on the surface of the positive electrode current collector, thereby producing the positive electrode.

In addition, for the negative electrode, a negative electrode having a negative electrode composite layer on the surface of the negative electrode current collector can be formed by applying a negative electrode slurry containing the first and second negative electrode active materials onto the negative electrode current collector by a method such as bar coating, casting, or spraying, and by drying the negative electrode slurry at 80 to 120° C.

The positive electrode slurry and the negative electrode slurry may each further include a solvent. Examples of the solvent include dimethyl sulfoxide (DMSO), isopropyl alcohol, N-methylpyrrolidone (NMP), acetone, water, and the like. The amount of the solvent is not particularly limited as long as it dissolves or disperses the components, in consideration of the slurry coating thickness and manufacturing yield, and provides a viscosity capable of exhibiting excellent thickness uniformity when the slurry is applied to a current collector.

If the pouch-type secondary battery according to the above-described embodiments does not further include a solid electrolyte, the secondary battery may be manufactured by housing a unit cell including the above-described positive electrode and negative electrode in a pouch-type battery case and then injecting an electrolyte.

The electrolyte may include an organic solvent and a lithium salt. The organic solvent serves as a medium through which ions involved in the electrochemical reactions of a battery can move, and may be used alone or as a mixture of two or more solvents selected from carbonate-based, ester-based, ether-based, ketone-based, alcohol-based, or aprotic solvents, and when two or more solvents are mixed, the mixing ratio may be appropriately adjusted depending on the desired battery performance. The lithium salt is dissolved in the organic solvent to act as a source of lithium ions in the battery, thereby enabling operation of a lithium secondary battery and promoting movement of lithium ions between a positive electrode and a negative electrode. Known lithium salts may be used at concentrations appropriate for their intended purposes. The electrolyte may further include known solvents to improve charge-discharge characteristics, flame retardancy, and the like, and may include known additives.

A pouch-type secondary battery according to one embodiment of this disclosure may further include electrode leads connected to the electrode assembly, a portion of which is exposed outside the pouch. The electrode leads may be connected to the electrode assembly via electrode tabs (not shown) extending from the electrode assembly accommodated in the pouch, and may transfer electrochemical energy of the unit cells included in the electrode assembly to the outside or transfer electrochemical energy from the outside to the unit cells.

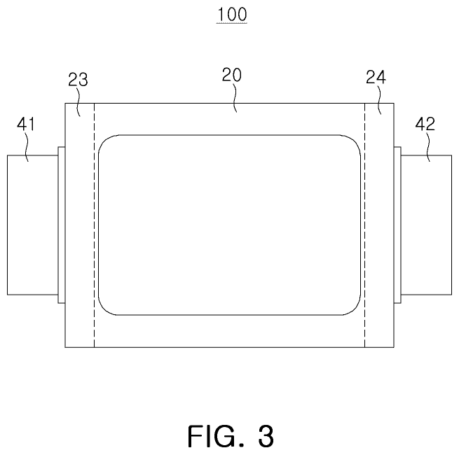

FIG. 3 is a diagram schematically illustrating example positions of first and second electrode leads and first and second sealing portions of a pouch-type secondary battery according to an embodiment of this disclosure. The electrode leads may be provided in pairs and may be provided at one side or both sides of an electrode assembly. Specifically, the electrode leads may include a first electrode lead and a second electrode lead, different from the first electrode lead. More specifically, the first electrode lead may be either a positive electrode lead or a negative electrode lead, and the second electrode lead may be the other. The positive electrode lead may be connected to the electrode assembly through a positive electrode tab extending from the electrode assembly, and the negative electrode lead may be connected to the electrode assembly through a negative electrode tab extending from the electrode assembly.

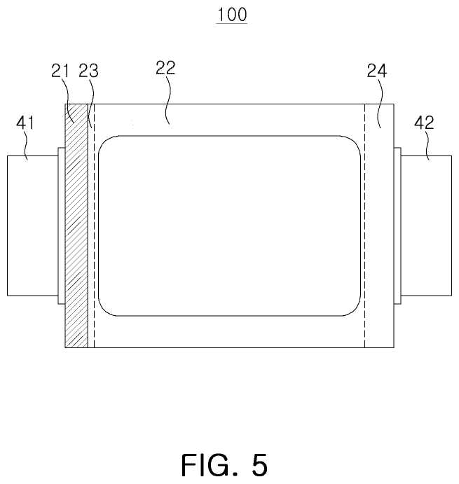

Although FIGS. 1 to 6 illustrate that the electrode leads (specifically, the positive electrode lead and the negative electrode lead) are provided on opposite sides of the pouch so as to face each other, this disclosure is not limited thereto. For example, although not illustrated in the drawings, the positive electrode lead and the negative electrode lead may be provided side-by-side on one side of the pouch so as to face the same direction.

According to one embodiment, the sealing portion may include a first sealing portion on the side where a first electrode lead is located; and a second sealing portion on the side where a second electrode lead is located. More specifically, the sealing portion may include a first sealing portion on the external surface of the pouch at the side where the connection between the pouch and the first electrode lead is located, a second sealing portion on the external surface of the side where the connection between the pouch and the second electrode lead is located, and may further include a third sealing portion and a fourth sealing portion (not shown) on the external surface of a side where no electrode lead is located. The electrode types (specifically, the positive electrode or the negative electrode) of the electrode leads connected to the pouch at the first sealing portion and the second sealing portion are not particularly limited. The first sealing portion and the second sealing portion are regions where the pouch and the electrode leads are connected, and in a pouch-type secondary battery, they are likely to have a relatively high insulation resistance defect rate and may have reduced durability due to pressure concentration when internal gas is generated.

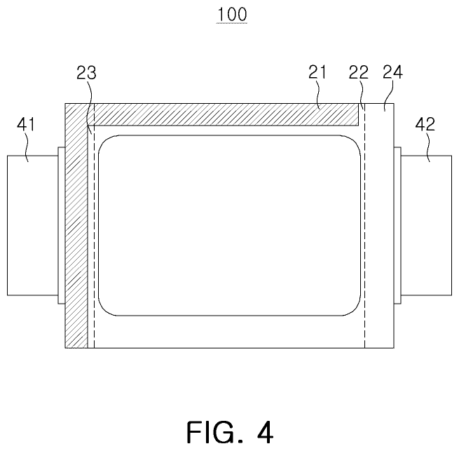

FIGS. 4 to 6 are plan views schematically illustrating a pouch-type secondary battery having a coating portion according to various embodiments of this disclosure, as viewed from above. Hereinafter, a pouch-type secondary battery having a coating portion according to various embodiments of this disclosure will be described in more detail with reference to FIGS. 4 to 6.

According to one embodiment of this disclosure, the coating portion may be formed in a region that includes at least a portion of one or both of the first sealing portion and the second sealing portion. As described above, the first sealing portion and the second sealing portion may be regions having a relatively high insulation resistance defect rate and low mechanical stability. Therefore, forming the coating portion in a region that includes at least a portion of one or both of the first and second sealing portions can improve the pouch's insulation resistance defect rate and effectively enhance thermal and mechanical stability. In this case, the region that includes at least a portion of one or both of the first and second sealing portions may additionally include sealing areas other than the first and second sealing portions (for example, the aforementioned third and fourth sealing portions).

According to an embodiment, the coating may be formed in at least a portion of the first sealing part or the second sealing part. The pouch-type secondary battery may be manufactured as a secondary battery module or pack including a plurality of pouch-type secondary batteries, as will be described later. Accordingly, if an abnormal condition occurs during operation of the secondary battery, heat generated in a single cell may transfer to adjacent cells, causing a thermal propagation phenomenon. When thermal propagation occurs, gas generated inside the pouch may vent uncontrollably from portions of the sealing parts that are weak in durability. When the coating is formed in at least a portion of either the first sealing part or the second sealing part, the sealing part that is more likely to vent during thermal propagation may be coated while the other sealing part may remain uncoated. Accordingly, the vent position can be identified as the region where the uncoated part is formed among the first and second sealing parts, allowing the gas discharge path to be predicted and enabling an easy response during thermal propagation.

According to an embodiment, the coating portion may be formed on the sealing end portion and the electrode-lead end portion of the side of the first sealing portion where the first electrode lead is located, or on the sealing end portion and the electrode-lead end portion of the side of the second sealing portion where the second electrode lead is located.

The sealing end portion may refer to the outermost corner of the side of the pouch where the electrode lead is located. The sealing end portion is relatively susceptible to mechanical defects caused by external impacts and may exhibit a high insulation resistance failure rate.

The electrode lead end may refer to the terminal of the portion where the pouch and the electrode lead are joined at the pouch seal. The electrode lead end may, like the sealing end, be relatively prone to insulation resistance defects and may have reduced durability due to pressure concentration when gas is generated inside the pouch.

Therefore, as described above, forming a coating on the sealing end portions and the electrode lead end portions, where poor insulation resistance relatively frequently occurs and durability is low, can more effectively and economically improve the performance and stability of the secondary battery. Further, by forming the coating on the sealing end portion and the electrode lead end portion on the side where the first electrode lead is located in the first sealing portion, or on the sealing end portion and the electrode lead end portion on the side where the second electrode lead is located in the second sealing portion, the vent location of the gas inside the pouch can be specified and the gas discharge path can be anticipated, enabling an easier response in the event of thermal propagation.

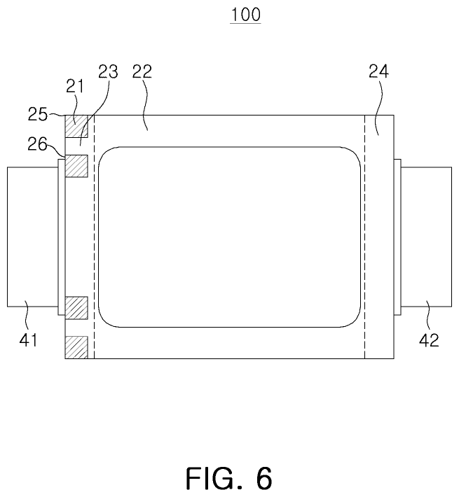

The sizes and shapes of the sealing end portion and the electrode lead end portion in the sealing portion are not particularly limited. For example, when the pouch-type secondary battery is viewed from the top, the sealing end portion and the electrode lead end portion may each have a square shape (see FIG. 6), and the length of one side of the square may be 0.1 to 50 cm.

The inorganic coating layer is not limited as long as it can enhance the nonconductivity of the sealing portion, reduce the occurrence of insulation resistance defects, and improve thermal and mechanical stability. Additionally, the manner of formation and the structure of the inorganic coating layer are not particularly limited.

According to one embodiment, the inorganic coating layer may include at least one member selected from the group consisting of metal oxides and carbides.

According to an embodiment, the metal oxide may include at least one selected from the group consisting of aluminum oxide, chromium oxide, titanium oxide, zirconium oxide, and yttrium oxide. The aforementioned metal oxide may have excellent electrical insulating properties and thermal stability. Accordingly, when the inorganic coating layer includes the aforementioned metal oxide, the inorganic coating layer may enhance the non-conductivity of the sealing portion, improve insulation resistance, and enhance thermal and mechanical stability.

According to an embodiment, the carbide material may include at least one carbide selected from the group consisting of tungsten carbide and chromium carbide. The above-described carbide material may exhibit excellent thermal and mechanical stability. Accordingly, when the inorganic coating layer includes the above-described carbide material, the thermal and mechanical stability of the sealing portion may be improved.

According to one embodiment, the inorganic coating layer may have a thickness of 1 to 200 μm. For example, the inorganic coating layer may have a thickness of 3 to 160 μm. When the thickness of the inorganic coating layer is within the above-described range, it may be advantageous for commercialization while effectively improving the sealing portion's electrical insulation, thermal stability, and mechanical stability.

### Method of Manufacturing a Pouch-Type Secondary Battery

A method of manufacturing a pouch-type secondary battery according to an embodiment of this disclosure may include: preparing a pouch-type secondary battery in which an electrode assembly is accommodated in a pouch; and forming, on an external surface of a sealing portion sealing the pouch, a coating portion on which an inorganic coating layer is formed and a non-coating portion on which an inorganic coating layer is not formed. By manufacturing the pouch-type secondary battery according to the method, the insulation resistance defect rate of the pouch-type secondary battery can be improved, and the thermal and mechanical stability of the pouch-type secondary battery can be enhanced. In the manufacturing method according to this disclosure, components of the pouch-type secondary battery, such as the pouch, the sealing portion, the coating portion, and the inorganic coating layer, can be applied in the same manner as those described above.

According to an embodiment, the formation of the inorganic coating layer may be performed by at least one method selected from the group consisting of plasma spray coating, brush coating, decal coating, slot die coating, inkjet printing, spin coating, and dip coating. For example, the formation of the inorganic coating layer may be performed by a plasma spray coating method. When the inorganic coating layer is formed using a plasma spray coating method, because the coating material is instantaneously melted by plasma, the heat applied to the sealing portion may be reduced. In addition, the melted coating material may rapidly solidify upon contacting the sealing portion at a low temperature to form the coating layer. Therefore, when the plasma spray coating method is used, the insulating property, thermal stability, and mechanical stability of the sealing portion may be effectively improved while minimizing damage to the sealing portion. secondary battery module and pack

The secondary battery module according to an embodiment of the present disclosure includes the pouch-type secondary battery according to any one of the above-described embodiments. Specifically, the secondary battery module may include a plurality of pouch-type secondary batteries.

A secondary battery pack according to one embodiment of this disclosure includes a pouch-type secondary battery according to any one of the above embodiments. Specifically, the secondary battery pack may include the above-described secondary battery module, and may be configured such that multiple secondary battery modules are coupled together.

The secondary battery module and battery pack may be suitably employed as a power source for medium-and large-sized devices, such as power tools, electric vehicles (EVs), hybrid electric vehicles (HEVs), and plug-in hybrid electric vehicles (PHEVs).

Only specific examples of implementations of certain embodiments are described. Variations, improvements and enhancements of the disclosed embodiments and other embodiments may be made based on the disclosure of this patent document.

### DESCRIPTION OF REFERENCE NUMERALS

10: Pouch
20: Sealing Part
21: Coating Layer
22: Non-coating portion
23: A First Sealing Part
24: Second Sealing Portion
25: Sealing End Portion
26: Electrode Lead Terminal
30: Inorganic Coating Layer
40: Electrode Lead
41: First Electrode Lead
42: Second Electrode Lead
100: Pouch-Type Secondary Battery
A: Length of the Pouch

1. A pouch-type secondary battery, comprising:
an electrode assembly; and
a pouch accommodating the electrode assembly, the pouch comprising:
a sealing portion sealing an external surface of the pouch; and an inorganic coating layer formed on an external surface of the sealing portion; wherein the sealing portion comprises a coating portion on which the inorganic coating layer is formed on the external surface of the sealing portion, and a non-coating portion on which the inorganic coating layer is not formed on the external surface of the sealing portion.

2. The pouch-type secondary battery of claim 1, further comprising an electrode lead connected to the electrode assembly and partially exposed outside the pouch.

3. The pouch-type secondary battery of claim 2, wherein the electrode lead comprises: a first electrode lead; and a second electrode lead, different from the first electrode lead.

4. The pouch-type secondary battery of claim 3, wherein the sealing portion comprises a first sealing portion on the side where the first electrode lead is located; and a second sealing portion on the side where the second electrode lead is located.

5. The pouch-type secondary battery of claim 4, wherein the coating portion is formed in a region including a part of at least one of the first sealing portion and the second sealing portion.

6. The pouch-type secondary battery of claim 4, wherein the coating portion is formed in at least a partial region of the first sealing part or the second sealing part.

7. The pouch-type secondary battery of claim 4, wherein the coating portion is formed on the sealing end portion and the electrode lead end portion on the side of the first sealing portion where the first electrode lead is located; or on the sealing end portion and the electrode lead end portion on the side of the second sealing portion where the second electrode lead is located.

8. The pouch-type secondary battery of claim 1, wherein the inorganic coating layer comprises at least one selected from the group consisting of metal oxides and carbides.

9. The pouch-type secondary battery of claim 8, wherein the metal oxide comprises at least one selected from the group consisting of aluminum oxide, chromium oxide, titanium oxide, zirconium oxide, and yttrium oxide.

10. The pouch-type secondary battery of claim 8, wherein the carbide material comprises at least one selected from the group consisting of tungsten carbide and chromium carbide.

11. The pouch-type secondary battery of claim 1, wherein the inorganic coating layer has a thickness of 1 to 200 μm.

12. A method of manufacturing a pouch-type secondary battery, comprising: preparing a pouch-type secondary battery in which an electrode assembly is accommodated in a pouch; and forming an inorganic coating layer on an external surface of a sealing portion sealing the external surface of the pouch, wherein the sealing portion comprises: a coating portion on which the inorganic coating layer is formed on the external surface of the sealing portion; and a non-coating portion on which the inorganic coating layer is not formed on the external surface of the sealing portion.

13. The method of claim 12, wherein the forming of the inorganic coating layer is performed by at least one method selected from the group consisting of plasma spray coating, brush coating, decal coating, slot die coating, inkjet printing, spin coating, and dip coating.
